(19) United States
(12) Patent Application Publication
(10) Pub. No.: US 2024/0145160 A1
(43) Pub. Date: May 2, 2024

(54) COIL COMPONENT

(71) Applicant: SAMSUNG ELECTRO-MECHANICS CO., LTD., Suwon-si (KR)

(72) Inventors: Tae Hyun Kim, Suwon-si (KR); Dong Hwan Lee, Suwon-si (KR); Dong Jin Lee, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/374,300

(22) Filed: Sep. 28, 2023

(30) Foreign Application Priority Data
Nov. 1, 2022 (KR) 10-2022-0143685

(51) Int. Cl. H01F 27/29; H01F 27/02; H01F 27/34

(52) U.S. Cl. CPC H01F 27/292; H01F 27/022; H01F 27/34

(57) ABSTRACT

A coil component includes a body including a first surface and a second surface opposing each other and first to fourth side surfaces connecting the first and second surfaces; a first coil disposed within the body and including a first lead-out portion and a second lead-out portion extending to at least one of the first to fourth side surfaces of the body; a second coil disposed within the body and including a third lead-out portion and a fourth lead-out portion extending to at least one of the first to fourth side surfaces of the body; first to fourth external electrodes disposed on two adjacent side surfaces of the first to fourth side surfaces of the body and respectively connected to the first to fourth lead-out portions.

### CROSS-REFERENCE TO RELATED APPLICATION(S)

This application claims benefit of priority to Korean Patent Application No. 10-2022-0143685 filed on Nov. 1, 2022 in the Korean Intellectual Property Office, the disclosure of which is incorporated herein by reference in its entirety.

### TECHNICAL FIELD

The present disclosure relates to a coil component.

An inductor, a coil component, is a representative passive electronic part used in electronic devices along with resistors and capacitors. Coil components may include array-type coil components including a plurality of coils in a single component to reduce a mounting area.

The array type coil component may have a noncoupled or coupled inductor type or a mixture of the above types according to a coupling coefficient or mutual inductance between the plurality of coils.

In coupled inductors, the system area may be reduced, as compared to single inductors, and peaks of current and voltage generated in output terminals may be lowered, thereby providing excellent efficiency. As demand for coupled power inductors for high current gradually increases, research into inductors with low direct current resistance (Rdc) and high heat dissipation characteristics is continuing to prevent heat generation due to high current.

### SUMMARY

An aspect of the present disclosure is to provide a coil component having low direct current resistance (R dc) and high heat dissipation characteristics.

According to an aspect of the present disclosure, a coil component includes a body including a first surface and a second surface opposing each other and first to fourth side surfaces connecting the first and second surfaces; a first coil disposed within the body and including a first lead-out portion and a second lead-out portion extending to at least one of the first to fourth side surfaces of the body; a second coil disposed within the body and including a third lead-out portion and a fourth lead-out portion extending to at least one of the first to fourth side surfaces of the body; a first external electrode disposed on two adjacent side surfaces of the first to fourth side surfaces of the body and connected to the first lead-out portion; a second external electrode disposed on two adjacent side surfaces of the first to fourth side surfaces of the body and connected to the second lead-out portion; a third external electrode disposed on two adjacent side surfaces of the first to fourth side surfaces of the body and connected to the third lead-out portion; and a fourth external electrode disposed on two adjacent side surfaces of the first to fourth side surfaces of the body and connected to the fourth lead-out portion.

According to an aspect of the present disclosure, a coil component includes a body including a first surface and a second surface opposing each other and first to fourth side surfaces connecting the first and second surfaces; a first coil disposed within the body and including a first lead-out portion and a second lead-out portion extending to at least one of the first to fourth side surfaces of the body; a second coil disposed within the body and including a third lead-out portion and a fourth lead-out portion extending to at least one of the first to fourth side surfaces of the body; a first external electrode disposed at a first corner of the body to cover three surfaces of the body and connected to the first lead-out portion; a second external electrode disposed at a second corner of the body to cover three surfaces of the body and connected to the second lead-out portion; a third external electrode disposed at a third corner of the body to cover three surfaces of the body and connected to the third lead-out portion; and a fourth external electrode disposed at a fourth corner of the body to cover three surfaces of the body and connected to the fourth lead-out portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view of a coil component according to a first embodiment;

FIG. 2 is a view illustrating the coil component of FIG. 1 viewed from above;

FIG. 3 is a view illustrating an upper coil pattern of the coil component of FIG. 1 viewed from above;

FIG. 4 is a view illustrating a lower coil pattern of the coil component of FIG. 1 viewed from above;

FIG. 5 is a schematic view of a coil component according to a second embodiment;

FIG. 6 is a view illustrating the coil component of FIG. 5 viewed from above;

FIG. 7 is a view illustrating an upper coil pattern of the coil component of FIG. 5 viewed from above;

FIG. 8 is a view illustrating a lower coil pattern of the coil component of FIG. 5 viewed from above;

FIG. 9 is another modified example of the coil component according to the second embodiment, and is a view illustrating the coil component viewed from above; and

FIG. 10 is a view illustrating a comparative example of a coil component having an existing electrode structure.

### DETAILED DESCRIPTION

Terms used in this application are only used to describe specific embodiments, and are not intended to limit the present disclosure. Singular expressions include plural expressions unless the context clearly dictates otherwise. In this application, terms such as “include”, “have” or the like are intended to designate that the features, numbers, steps, operations, components, parts, or combinations thereof described in the specification exist, and it should be understood that the presence or addition of one or more other features, numbers, steps, operations, components, parts, or combinations thereof is not precluded. Throughout the specification, “on” means located above or below the target part, and does not necessarily mean that it is located on the upper side relative to the direction of gravity.

In addition, “coupling” does not mean only the case of direct physical contact between components in the contact relationship between respective components, but should be used as a concept that encompasses even the case of another configuration intervening between the respective components to respectively be in contact with the configurations.

Since the size and thickness of each component illustrated in the drawings are arbitrarily illustrated for convenience of description, the present disclosure is not necessarily limited to those illustrated.

In the drawings, the X-direction may be defined as the first direction or length direction, the Y-direction as the second direction or width direction, and the Z-direction as the third direction or thickness direction.

Hereinafter, a coil component according to an embodiment of the present disclosure will be described in detail with reference to the accompanying drawings, and in the description with reference to the accompanying drawings, the same or corresponding components are assigned the same reference numerals, and overlapping descriptions thereof will be omitted.

Various types of electronic components are used in electronic devices, and among these electronic components, various types of coil components may be appropriately used for removing noise.

For example, in electronic devices, coil components may be used as power inductors, HF inductors, general beads, GHz beads, common mode filters, etc.

### Coil Component According to First Embodiment

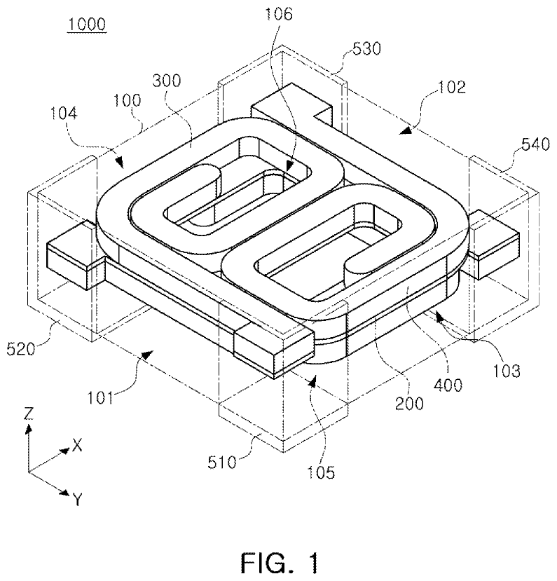

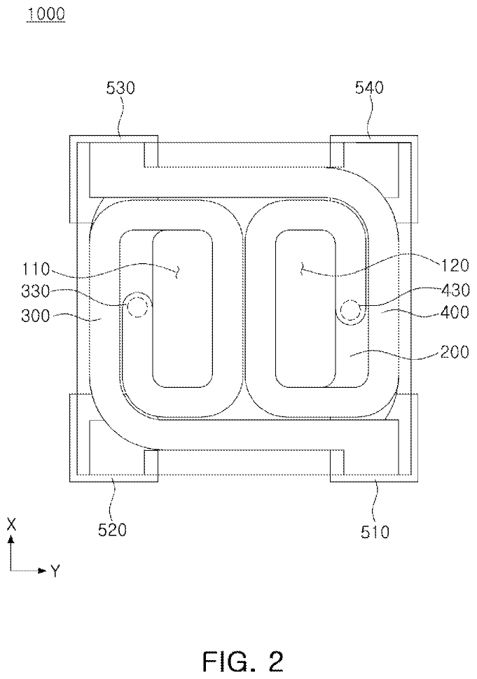

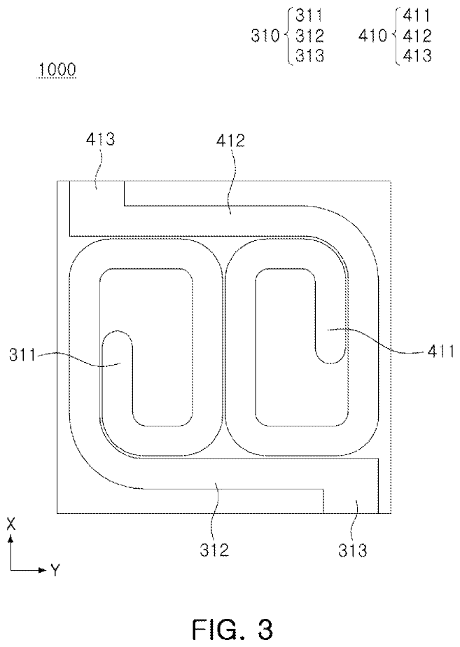

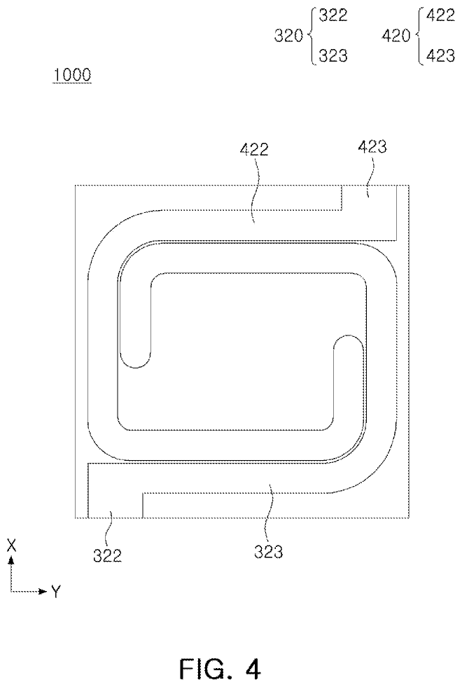

FIG. 1 is a diagram schematically illustrating a coil component according to a first embodiment. FIG. 2 is a view illustrating the coil component of FIG. 1 viewed from above. FIG. 3 is a view illustrating an upper coil pattern of the coil component of FIG. 1 viewed from above. FIG. 4 is a view illustrating a lower coil pattern of the coil component of FIG. 1 viewed from above.

Referring to FIGS. 1 and 2, a coil component 1000 according to the present embodiment includes a body 100, a first coil 300, a second coil 400, and first to fourth external electrodes 510, 520, 530 and 540.

The body 100 forms the overall appearance of the coil component 1000 according to the present embodiment, and a support substrate 200, the first coil 300, and the second coil 400 may be embedded therein.

The body 100 may be formed in the shape of a hexahedron as a whole.

Based on FIG. 1, the body 100 includes a first side surface 101 and a second side surface 102 opposing each other in the X-direction (first direction), a third side surface 103 and a fourth side surface 104 opposing each other in the Y-direction (second direction), and a first surface 105 and a second surface 106 opposing each other in the Z-direction (third direction). Each of the first to fourth side surfaces of the body 100 corresponds to a surface of the body 100 connecting the first and second surfaces of the body 100. Hereinafter, the lower surface and the upper surface of the body 100 may refer to the first surface 105 and the second surface 106 of the body 100, respectively, based on the direction of FIG. 1.

The body 100 may include an insulating resin and a magnetic material. In detail, the body 100 may be formed by stacking one or more magnetic composite sheets in which a magnetic material is dispersed in an insulating resin. The magnetic material may be ferrite or metallic magnetic powder. The ferrite may be at least one of, for example, spinel ferrites such as Mg—Zn, Mn—Zn, Mn—Mg, Cu—Zn, Mg—Mn—Sr, Ni—Zn, Ba—Zn, Ba—Mg, etc., hexagonal ferrites such as Ba—Ni, Ba—Co, Ba—Ni—Co, etc., Y-type garnet ferrites, and Li-type ferrites. The metal magnetic powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder Alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder. The magnetic metal powder may be amorphous or crystalline. For example, the magnetic metal powder may be Fe—Si—B—Cr-based amorphous alloy powder, but is not necessarily limited thereto. Each of the ferrite and magnetic metal powder may have an average diameter of about 0.1 μm to about 30 μm, but the present disclosure is not limited thereto. The body 100 may include two or more types of magnetic materials dispersed in resin. In this case, when the magnetic materials are of different types, it means that the magnetic materials dispersed in the resin are distinguished from each other by one of average diameter, composition, crystallinity, and shape. The insulating resin may include epoxy, polyimide, liquid crystal polymer, etc. alone or in combination, but is not limited thereto.

The body 100 may include a first core 110 penetrating the support substrate 200 and the first coil 300, and a second core 120 penetrating the support substrate 200 and the second coil 400, and the first core 110 and the second core 120 may be spaced apart from each other. The cores 110 and 120 may be formed by filling respective through-holes of the first and second coils 300 and 400 with at least a portion of the magnetic composite sheet in the process of laminating and curing the magnetic composite sheet, but the present disclosure is not limited thereto.

The support substrate 200 may be disposed inside the body 100. In detail, the support substrate 200 may be buried inside the body 100. The support substrate 200 supports the coils 300 and 400 to be described later. However, depending on an embodiment, the support substrate 200 may not be provided, and for example, in the case of using a winding-type coil, the support substrate 200 may not be required separately.

The support substrate 200 may be formed of an insulating material including a thermosetting insulating resin such as epoxy resin, a thermoplastic insulating resin such as polyimide, or a photosensitive insulating resin, or may be formed of an insulating material impregnated with a reinforcing material such as glass fiber or an inorganic filler in the insulating resin. For example, the support substrate 200 may be formed of an insulating material such as prepreg, Ajinomoto Build-up Film (ABF), FR-4, Bismaleimide Triazine (BT) film, Photo Imageable Dielectric (PID) film, etc., but the present disclosure is not limited thereto.

Examples of the inorganic filler may include at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

When the support substrate 200 is formed of an insulating material including a reinforcing material, the support substrate 200 may provide superior rigidity. When the support substrate 200 is formed of an insulating material that does not contain glass fibers, the support substrate 200 is advantageous in reducing the thickness of the part. When the support substrate 200 is formed of an insulating material containing a photosensitive insulating resin, the number of processes for forming the coils 300 and 400 is reduced, which is advantageous in reducing production costs, which may be advantageous to form fine vias.

The first and second coils 300 and 400 may be spaced apart from each other on the support substrate 200 and exhibit characteristics of the coil component 1000 according to the present embodiment. For example, the coil component 1000 according to the present embodiment may be a coupled inductor in which the absolute value of the coupling coefficient k between the first and second coils 300 and 400 is greater than 0 and less than 1, but is not limited thereto.

The first coil 300 has a first winding portion 311 forming at least one turn with the first core 110 as an axis, and a first extension portion 312 extending from one end of the first winding portion 311 to surround both the first and second cores 110 and 120, and has a first lead-out portion 313 and a second lead-out portion 323 connected to one end and the other end of the first coil 300, respectively.

The first and second lead-out portions 313 and 323 extend to at least one side surface of the first to fourth side surfaces of the body 100. In detail, referring to FIG. 1, the first and second lead-out portions 313 and 323 may extend to the first side surface 101 of the body 100. The first and second lead-out portions 313 and 323 extend to the first side surface 101 of the body 100 and are connected to the first and second external electrodes 510 and 520 to be described later, respectively.

The second coil 400 has a second winding portion 411 forming at least one turn with the second core 120 as an axis, and a second extension portion 412 extending from one end of the second winding portion 411 to surround both the first and second cores 110 and 120, and has a third lead-out portion 413 and a fourth lead-out portion 423 connected to one end and the other end of the second coil 400, respectively.

The third and fourth lead-out portions 413 and 423 extend to at least one side surface of the first to fourth side surfaces of the body 100. In detail, referring to FIG. 1, the third and fourth lead-out portions 413 and 423 may extend to the second side surface 102 of the body 100. The third and fourth extension portions 413 and 423 extend to the second side surface of the body 100 and are respectively connected to the third and fourth external electrodes 530 and 540 to be described later.

The cross-sectional area of the first lead-out portion 313 is larger than the cross-sectional areas of the first winding portion 311 and the first extension portion 312, and the cross-sectional area of the second lead-out portion 323 is larger than the cross-sectional areas of the first winding portion 311 and the first extension portion 312. In this case, since the cross-sectional area of the electrode inside the coil is increased, the DC resistance (Rdc) may be reduced. In detail, referring to FIGS. 3 and 4, when the area in which the first lead-out portion 313 extends to the first side surface of the body 100 is referred to as the cross-sectional area of the first lead-out portion 313 and when the area of the cross section of the first winding portion 311 and the first extension portion 312 perpendicular to the direction in which the first coil 300 is wound around the core is referred to as the cross-sectional area of the first winding portion 311 and the first extension portion 312; the cross-sectional area of the first lead-out portion 313 is larger than the cross-sectional area of the first winding portion 311 and the first extension portion 312. Similarly, the same is applied to the second lead-out portion 413, and a detailed description thereof is omitted since it is redundant.

The cross-sectional area of the third lead-out portion 413 is larger than the cross-sectional areas of the second winding portion 411 and the second extension portion 412, and the cross-sectional area of the fourth lead-out portion 423 is larger than the cross-sectional area of the second winding portion 411 and the second extension portion 412. In this case, since the cross-sectional area of the electrode inside the coil is increased, the DC resistance (Rdc) may be reduced. In detail, referring to FIGS. 3 and 4, when the area in which the third extension portion 413 extends to the second side surface of the body 100 is referred to as the cross-sectional area of the third extension portion 413 and when the area of the cross section of the second winding portion 411 and the second extension portion 412 perpendicular to the direction in which the second coil 400 is wound around the core is referred to as the cross-sectional area of the second winding portion 411 and the second extension portion 412; the cross-sectional area of the third lead-out portion 413 is larger than the cross-sectional area of the second winding portion 411 and the second extension portion 412. Similarly, the same is applied to the fourth lead-out portion 423, and a detailed description thereof is omitted since it is redundant.

Referring to FIGS. 1 to 4, based on the direction of FIG. 1, the first coil 300 may include a first upper coil pattern 310 disposed on the upper surface of the support substrate 200, a first lower coil pattern 320 disposed on the lower surface of the support substrate 200, and a via 330 penetrating the support substrate 200 and connecting the first upper coil pattern 310 and the first lower coil pattern 320.

The first upper coil pattern 310 may have a first upper winding portion 311 forming at least one turn with the first core 110 as an axis, a first upper extension portion 312 extending from one end of the first upper winding portion 311 to surround both the first and second cores 110 and 120 and having one end disposed closer to the surface of the body 100 than an outermost turn of the first upper winding portion 311, and a first lead-out portion 313 extending from the first upper extension portion 312 to the first side surface 101 of the body 100.

The first lower coil pattern 320 may have a first lower extension portion 322 disposed to surround both the first and second cores 110 and 120, and a second lead-out portion 323 extending from the first lower extension portion 322 to the first side surface 101 of the body 100. For example, the first winding portion may not be formed on the first lower coil pattern 320 but may be formed only on the first upper coil pattern 310.

The other end of the first upper winding portion 311 and the other end of the first lower winding portion 321 are contact-connected to the via 330, respectively. The first and second external electrodes 510 and 520 to be described later are disposed on the first side surface 101 of the body 100, and are thus connected to the first lead-out portion 313 and the second lead-out portion 323. Therefore, the first coil 300 may function as a single coil in a form extending from the first lead-out portion 313 to the second lead-out portion 323.

Referring to FIGS. 1 to 4, based on the direction of FIG. 1, the second coil 400 may include a second upper coil pattern 410 disposed on the upper surface of the support substrate 200, a second lower coil pattern 420 disposed on the lower surface of the support substrate 200, and a via 430 penetrating the support substrate 200 and connecting the second upper coil pattern 410 and the second lower coil pattern 420.

The second upper coil pattern 410 may have a second upper winding portion 411 forming at least one turn with the second core 120 as an axis, a second upper extension portion 412 extending from one end of the second upper winding portion 411 to surround both the first and second cores 110 and 120 and having one end disposed closer to the surface of the body 100 than an outermost turn of the second upper winding portion 411, and a third lead-out portion 413 extending from the second upper extension portion 412 to the second side surface 102 of the body 100. The second lower coil pattern 420 may have a second lower extension portion 422 disposed to surround both the first and second cores 110 and 120, and a fourth lead-out portion 423 extending from the second lower extension portion 422 to the second side surface of the body 100. For example, the second winding portion may not be formed on the second lower coil pattern 420, but may be formed only on the first upper coil pattern 410.

The other end of the second upper winding portion 411 and the other end of the second lower winding portion 421 are contact-connected to the via 430, respectively. The third and fourth external electrodes 530 and 540 to be described later are disposed on the second side surface of the body 100, and are thus connected to the third lead-out portion 413 and the fourth lead-out portion 423. Therefore, the second coil 400 may function as a single coil extending from the third lead-out portion 413 to the fourth lead-out portion 423.

The first and second coils 300 and 400 may be plating patterns formed using a plating process used in the art, for example, a method such as pattern plating, anisotropic plating, isotropic plating, or the like, and may be formed into a multilayer structure using a plurality of processes among these processes.

Each of the first and second coils 300 and 400 may include a seed layer contacting the support substrate 200 and a plating layer disposed on the seed layer. The seed layer may be formed by a thin film process such as sputtering or an electroless plating process. When the seed layer is formed through a thin film process such as sputtering, at least a portion of the material constituting the seed layer may penetrate the surface of the support substrate 200, which can be confirmed by the fact that the concentration of the metal material constituting the seed layer in the support substrate 200 varies in the Z-direction of the body 100.

The seed layer may have a thickness of 1.5 μm or more and 3 μm or less. If the thickness of the seed layer is less than 1.5 μm, it is difficult to implement the seed layer, and plating defects may occur in a subsequent process. If the thickness of the seed layer exceeds 3 μm, it is difficult to form a relatively large volume of the plating layer within the limited volume of the body 100, and the process time may increase.

A via may include at least one conductive layer. For example, when forming vias by electroplating, the via may include a seed layer formed on an inner wall of the via hole penetrating the support substrate 200 and an electroplating layer filling the via hole in which the seed layer is formed. The seed layer of the via is formed together with the seed layers of the first and second coils 300 and 400 in the same process and may be formed integrally with each other, or is formed in the process different from the process of the seed layers of the first and second coils 300 and 400, to have a boundary formed therebetween. The electroplating layer of the via is formed together with the plating layers of the first and second coils 300 and 400 in the same process and formed integrally with each other, or is formed in the process different from the process of the plating layers of the first and second coils 300 and 400 to have a boundary formed therebetween.

Each of the coils 300 and 400 and vias is formed of a conductive material such as copper (Cu), aluminum (Al), silver (Ag), tin (Sn), gold (Au), nickel (Ni), lead (Pb), titanium (Ti), chromium (Cr) or alloys thereof, but is not limited thereto. As a non-limiting example, the seed layer includes at least one of molybdenum (Mo), chromium (Cr), copper (Cu), and titanium (Ti), and the plating layer may include copper (Cu).

The first to fourth external electrodes 510, 520, 530, and 540 are disposed to be spaced apart from each other on two adjacent side surfaces among the first to fourth side surfaces of the body 100. Referring to FIG. 1, the first external electrode 510 is disposed on first and third side surfaces 101 and 103 of the body 100, the second external electrode 520 is disposed on the first and fourth side surfaces 101 and 104 of the body 100, the third external electrode 530 is disposed on the second and fourth side surfaces 102 and 104 of the body 100, and the fourth external electrode 540 is disposed on the second and third side surfaces 102 and 103 of the body 100.

The first external electrode 510 may cover a corner between the first side surface 101 and the third side surface 103 of the body 100. The second external electrode 520 may cover a corner between the first side surface 101 and the fourth side surface 104 of the body 100. The third external electrode 530 may cover a corner between the second side surface 102 and the fourth side surface 104 of the body 100. The fourth external electrode 540 may cover a corner between the second side surface 102 and the third side surface 103 of the body 100.

The first to fourth external electrodes 510, 520, 530, and 540 may extend to the first surface 105 of the body 100. For example, the first to fourth external electrodes 510, 520, 530, and 540 may be disposed at points where three adjacent surfaces of the body 100 come into contact.

DC resistance (Rdc) may be divided into DC resistance (Rdc) generated by the coil and DC resistance (Rdc) generated by the electrode inside the coil. Since the direct current resistance (Rdc) generated by the coil is significantly low, the direct current resistance (Rdc) due to the electrode inside the coil occupies a relatively large portion. The inductor according to an embodiment of the present disclosure has a newly designed electrode shape that has a greatest effect on thermal conduction to reduce DC resistance (Rdc) generated from internal electrodes.

In the case of the present disclosure, since the external electrode is disposed on two adjacent side surfaces of the body, the path through which the heat generated from the coil component is transferred to the substrate is increased, and the thermal resistance is reduced.

The first and second external electrodes 510 and 520 are commonly disposed on the first side surface 101 of the body 100, and are connected to the first and second lead-out portions 313 and 323 extending to the first side surface 101 of the body 100. For example, in the case of this embodiment, the first lead-out portion 313 is connected to the first external electrode 510 on one surface of the first lead-out portion 313, and the second lead-out portion 323 is connected to the second external electrode 520 on one surface of the second lead-out portion 323.

The third and fourth external electrodes 530 and 540 are commonly disposed on the second side surface 102 of the body 100, and are connected to the third and fourth lead-out portions 413 and 423 extending to the second side surface 102 of the body 100. For example, in the case of the present embodiment, the third lead-out portion 413 is connected to the third external electrode 530 on one surface of the third lead-out portion 413, and the fourth lead-out portion 423 is connected to the fourth external electrode 540 on one surface of the fourth lead-out portion 423.

The first to fourth external electrodes 510, 520, 530, and 540 may be formed using a paste containing a metal having excellent electrical conductivity, and for example, the paste may be a conductive paste containing nickel (Ni), copper (Cu), tin (Sn), or silver (Ag) alone or alloys thereof. In addition, a plating layer may be provided to cover each of the first to fourth external electrodes 510, 520, 530, and 540. In this case, the plating layer may include at least one selected from the group consisting of nickel (Ni), copper (Cu), and tin (Sn), and for example, a nickel (Ni) layer and a tin (Sn) layer may be sequentially formed.

On the other hand, although not illustrated, when the body 100 includes a conductive magnetic material, the coil component 1000 may further include insulating layers disposed on surfaces of the first and second coils 300 and 400.

### Coil Component According to Second Embodiment

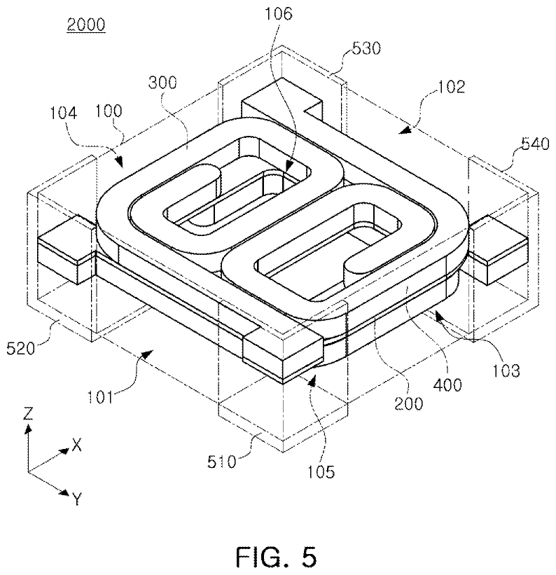

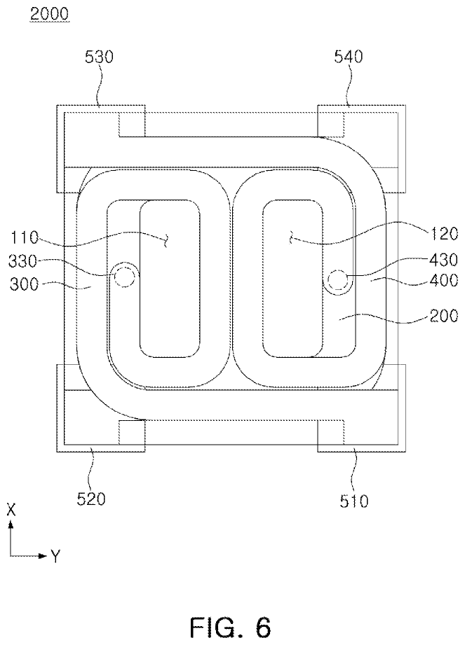

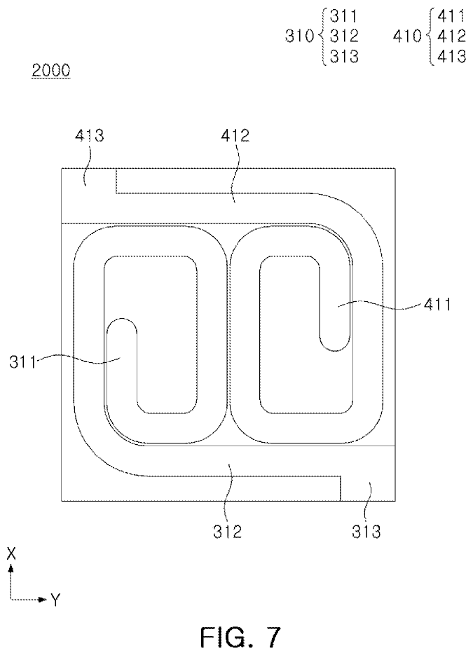

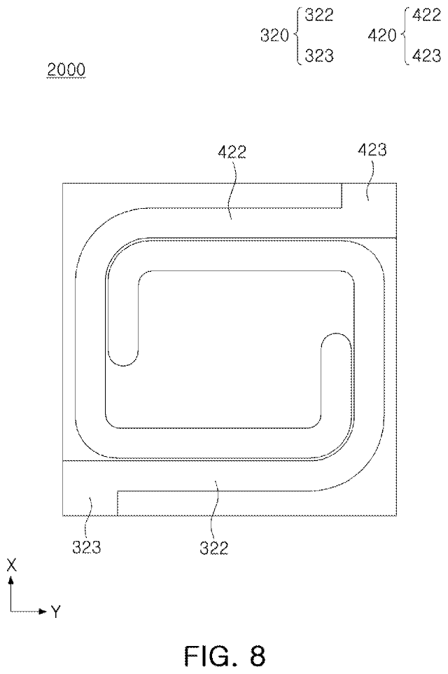

FIG. 5 is a diagram schematically illustrating a coil component according to a second embodiment. FIG. 6 is a view illustrating the coil component of FIG. 5 viewed from above. FIG. 7 is a view illustrating an upper coil pattern of the coil component of FIG. 5 viewed from above. FIG. 8 is a view illustrating a lower coil pattern of the coil component of FIG. 5 viewed from above. Hereinafter, differences from the coil component according to the first embodiment will be described in detail.

In the case of a coil component 2000 according to the second embodiment, compared to the coil component 1000 according to the first embodiment, connection structures of the lead-out portions 313, 323, 413, and 423 and the external electrodes 510, 520, 530, and 540 are different therefrom.

In detail, the first lead-out portion 313 is also connected to the first external electrode 510 and the third side surface 103 of the body 100, the second lead-out portion 323 is also connected to the second external electrode 520 and the fourth side surface 104 of the body 100, the third lead-out portion 413 is also connected to the third external electrode 530 and the fourth side surface 104 of the body 100, and the fourth lead-out portion 423 is also connected to the fourth external electrode 540 and the third side surface 103 of the body 100.

For example, the first lead-out portion 313 is connected to the first external electrode 510 on two surfaces of the first lead-out portion 313, the second lead-out portion 323 is connected to the second external electrode 520 on two surfaces of the second lead-out portion 323, the third lead-out portion 413 is connected to the third external electrode 530 on two surfaces of the third lead-out portion 413, and the fourth lead-out portion 423 is connected to the fourth external electrode 540 on two surfaces of the fourth lead-out portion 423.

In this manner, since the lead-out portion is in contact with the external electrode on two surfaces, and the cross-sectional area of the electrode, which is the path of current transmission, increases, and the electrical resistance decreases.

Other contents are substantially the same as those described above in the description of the first embodiment, and thus, detailed descriptions are omitted.

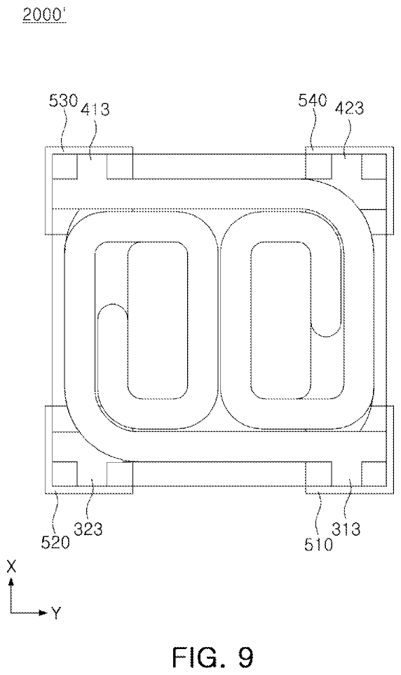

FIG. 9 is a view illustrating a coil component 2000′ viewed from above as another modified example of the coil component according to the second embodiment.

In the modified example, two surfaces of the first lead-out portion 313 connected to the first external electrode 510 are spaced apart from each other, and two surfaces of the second lead-out portion 323 connected to the second external electrode 520 are spaced apart from each other, two surfaces of the third lead-out portion 413 connected to the third external electrode 530 are spaced apart from each other, and two surfaces of the fourth lead-out portion 423 connected to the fourth external electrode 540 are spaced apart from each other.

Furthermore, a portion of the body 100 is filled between the two surfaces of the first lead-out portion 313 connected to the first external electrode 510, a portion of the body 100 is filled between the two surfaces of the second lead-out portion 323 connected to the second external electrode 520, a portion of the body 100 is filled between the two surfaces of the third lead-out portion 413 connected to the third external electrode 530, and a portion of the body 100 may be filled between the two surfaces of the fourth lead-out portion 423 connected to the fourth external electrode 540.

Other contents are substantially the same as those described above in the description of the first and second embodiments, and thus, detailed descriptions are omitted.

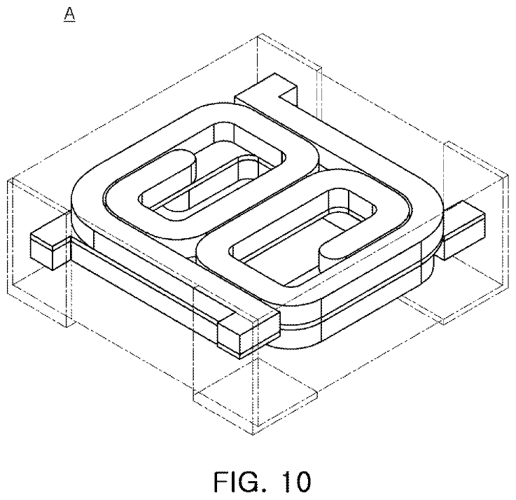

FIG. 10 illustrates a comparative example of a coil component having an existing electrode structure. Referring to FIG. 10, an external electrode of a coil component A has an L shape.

In Table 1 below, when the coil electrode structure is changed as in the first and second embodiments of the present disclosure under the same condition of the first and second coils 300 and 400, it shows the value and change rate of DC resistance (Rdc), as compared to the existing electrode structure. 8080_2.0T_R33 model was used as the coil component.

TABLE 1

| | Maximum R_{dc} (mΩ) | R_{dc} Change Rate (%) |
|---|---|---|
| Existing Electrode | 5.55 | 100 |
| First Embodiment | 5.309 | 95.7 |
| Second Embodiment | 4.87 | 87.7 |

Table 2 below shows the power loss value and change ratio (loss ratio), as compared to the existing electrode structure, when the coil electrode structure is changed as in the first and second embodiments of the present disclosure under the same condition of the first and second coils 300 and 400. The same coil components as those above were used and tested under 22A (ampere) conditions.

TABLE 2

| | Power loss (W) | Loss Ratio (%) |
|---|---|---|
| Existing Electrode | 2.7426 | 100 |
| First Example | 2.6052 | 95.0 |
| Second Example | 2.4326 | 88.7 |

Table 3 below shows the temperature change value and change rate, compared to the existing electrode structure, when the coil electrode structure is changed as in the first and second embodiments of the present disclosure, under the same condition of the first and second coils 300 and 400. The same coil components as those above were used and tested under 22A (ampere) conditions.

TABLE 3

| | Temperature Change | |
|---|---|---|
| | Value (° C.) | Change Rate (%) |
| Existing Electrode | 43.92 | 100 |
| First Example | 40.52 | 92.3 |
| Second Example | 37.34 | 85.0 |

Referring to the results of Tables 1 to 3, it can be seen that direct current resistance (Rdc) is reduced and heat dissipation characteristics are improved by the structure of the embodiment of the present disclosure. For example, compared to the existing electrode structure, the embodiments of the present disclosure have a difference in the arrangement form of the external electrode and the bonding structure with the lead-out portion, showing a significant difference in result.

In detail, the first to fourth external electrodes 510, 520, 530, and 540 of the present disclosure may be disposed on two adjacent side surfaces of the body 100, and may extend to the lower surface of the body 100. In this case, a path through which heat generated from the coil component is transferred to the substrate is increased, and thermal resistance is reduced. In addition, since the cross-sectional area of the electrode, which is the path of current transmission, is increased, the electrical resistance is reduced.

As set forth above, according to an embodiment, in the coupled inductor, low direct current resistance (Rdc) and high heat dissipation characteristics may be implemented.

While example embodiments have been illustrated and described above, it will be apparent to those skilled in the art that modifications and variations could be made without departing from the scope of the present disclosure as defined by the appended claims.

What is claimed is:

1. A coil component comprising:
a body including a first surface and a second surface opposing each other and first to fourth side surfaces connecting the first and second surfaces;
a first coil disposed within the body and including a first lead-out portion and a second lead-out portion extending to at least one of the first to fourth side surfaces of the body;
a second coil disposed within the body and including a third lead-out portion and a fourth lead-out portion extending to at least one of the first to fourth side surfaces of the body;
a first external electrode disposed on two adjacent side surfaces of the first to fourth side surfaces of the body and connected to the first lead-out portion;
a second external electrode disposed on two adjacent side surfaces of the first to fourth side surfaces of the body and connected to the second lead-out portion;
a third external electrode disposed on two adjacent side surfaces of the first to fourth side surfaces of the body and connected to the third lead-out portion; and
a fourth external electrode disposed on two adjacent side surfaces of the first to fourth side surfaces of the body and connected to the fourth lead-out portion.

2. The coil component of claim 1, wherein the first and second side surfaces of the body face each other, and
the third and fourth side surfaces of the body face each other.

3. The coil component of claim 2, wherein the first external electrode is disposed on first and third side surfaces of the body,
the second external electrode is disposed on first and fourth side surfaces of the body,
the third external electrode is disposed on second and fourth side surfaces of the body, and
the fourth external electrode is disposed on the second and third side surfaces of the body.

4. The coil component of claim 3, wherein the first external electrode covers a corner between the first and third side surfaces of the body,
the second external electrode covers a corner between the first and fourth side surfaces of the body,
the third external electrode covers a corner between the second and fourth side surfaces of the body, and
the fourth external electrode covers a corner between the second and third side surfaces of the body.

5. The coil component of claim 4, wherein the first to fourth external electrodes extend to the first surface of the body.

6. The coil component of claim 4, wherein the first and second lead-out portions are connected to the first and second external electrodes at the first side surface of the body, respectively, and
the third and fourth lead-out portions are connected to the third and fourth external electrodes at the second side surface of the body, respectively.

7. The coil component of claim 6, wherein the first lead-out portion is connected to the first external electrode on one surface of the first lead-out portion,
the second lead-out portion is connected to the second external electrode on one surface of the second lead-out portion,
the third lead-out portion is connected to the third external electrode on one surface of the third lead-out portion, and
the fourth lead-out portion is connected to the fourth external electrode on one surface of the fourth lead-out portion.

8. The coil component of claim 6, wherein the first lead-out portion is also connected to the first external electrode and the third side surface of the body,
the second lead-out portion is also connected to the second external electrode and the fourth side surface of the body,
the third lead-out portion is also connected to the third external electrode and the fourth side surface of the body, and
the fourth lead-out portion is also connected to the fourth external electrode and the third side surface of the body.

9. The coil component of claim 8, wherein the first lead-out portion is connected to the first external electrode at two surfaces of the first lead-out portion,
the second lead-out portion is connected to the second external electrode at two surfaces of the second lead-out portion,
the third lead-out portion is connected to the third external electrode at two surfaces of the third lead-out portion, and
the fourth lead-out portion is connected to the fourth external electrode at two surfaces of the fourth lead-out portion.

10. The coil component of claim 9, wherein the two surfaces of the first lead-out portion connected to the first external electrode are spaced apart from each other,
the two surfaces of the second lead-out portion connected to the second external electrode are spaced apart from each other,
the two surfaces of the third lead-out portion connected to the third external electrode are spaced apart from each other, and
the two surfaces of the fourth lead-out portion connected to the fourth external electrode are spaced apart from each other.

11. The coil component of claim 10, wherein a portion of the body is filled between the two surfaces of the first lead-out portion connected to the first external electrode,
a portion of the body is filled between the two surfaces of the second lead-out portion connected to the second external electrode,
a portion of the body is filled between the two surfaces of the third lead-out portion connected to the third external electrode, and
a portion of the body is filled between the two surfaces of the fourth lead-out portion connected to the fourth external electrode.

12. The coil component of claim 8, wherein the body further includes first and second cores spaced apart from each other,
the first coil further includes a first winding portion having at least one turn around the first core, and a first extension portion extending from one end of the first winding portion to surround the first and second cores and
the second coil further includes a second winding portion having at least one turn around the second core, and a second extension portion extending from one end of the second winding portion to surround the first and second cores.

13. The coil component of claim 12, wherein a cross-sectional area of the first lead-out portion is larger than a cross-sectional area of the first winding portion and a cross-sectional area of the first extension portion of the first coil,
a cross-sectional area of the second lead-out portion is larger than the cross-sectional area of the first winding portion and the cross-sectional area of the first extension portion of the first coil,
a cross-sectional area of the third lead-out portion is larger than a cross-sectional area of the second winding portion and a cross-sectional area of the second extension portion of the second coil, and
a cross-sectional area of the fourth lead-out portion is larger than the cross-sectional area of the second winding portion and the cross-sectional area of the second extension portion of the second coil.

14. The coil component of claim 12, further comprising a support substrate disposed within the body to support the first and second coils.

15. The coil component of claim 14, wherein the first coil includes a first upper coil pattern disposed on one surface of the support substrate, a first lower coil pattern disposed on the other surface of the support substrate facing the one surface of the support substrate, and a first via penetrating the support substrate and connecting the first upper coil pattern and the first lower coil pattern and
the second coil includes a second upper coil pattern disposed to be spaced apart from the first upper coil pattern on the one surface of the support substrate, and a second lower coil pattern disposed to be spaced apart from the first lower coil pattern on the other surface of the support substrate, and a second via penetrating the support substrate and connecting the second upper coil pattern and the second lower coil pattern.

16. The coil component of claim 15, wherein the first and second winding portions include only on the first and second upper coil patterns.

17. A coil component comprising:
a body including a first surface and a second surface opposing each other and first to fourth side surfaces connecting the first and second surfaces;
a first coil disposed within the body and including a first lead-out portion and a second lead-out portion extending to at least one of the first to fourth side surfaces of the body;
a second coil disposed within the body and including a third lead-out portion and a fourth lead-out portion extending to at least one of the first to fourth side surfaces of the body;
a first external electrode disposed at a first corner of the body to cover three surfaces of the body and connected to the first lead-out portion;
a second external electrode disposed at a second corner of the body to cover three surfaces of the body and connected to the second lead-out portion;
a third external electrode disposed at a third corner of the body to cover three surfaces of the body and connected to the third lead-out portion; and
a fourth external electrode disposed at a fourth corner of the body to cover three surfaces of the body and connected to the fourth lead-out portion.

18. The coil component of claim 17, wherein each of the first to fourth external electrodes covers a portion of the first surface of the body.

19. The coil component of claim 17, wherein each of the first to fourth external electrodes is spaced apart from the second surface of the body.

20. The coil component of claim 17, further comprising a support substrate disposed within the body to support the first and second coils,
wherein the first and third lead-out portions are disposed on one surface of the support substrate and the second fourth lead-out portions are disposed on another surface of the support substrate opposing the one surface.
